(19) United States
(12) Patent Application Publication
(10) Pub. No.: US 2026/0242156 A1
(43) Pub. Date: Aug. 20, 2026

(54) RETRACTABLE SLIDING CHUTE AND TRANSPORT SYSTEM

(71) Applicants: DAIFUKU OCEANIA LIMITED, Rosedale (NZ); DAIFUKU CO., LTD., Osaka-shi, Osaka (JP)

(72) Inventors: Ren Hong WONG, Kuala Lumpur (MY); Muhammad Khairul Aizat BIN ALIAS, Kuala Lumpur (MY)

(73) Assignees: DAIFUKU OCEANIA LIMITED, Rosedale (NZ); DAIFUKU CO., LTD., Osaka-shi, Osaka (JP)

(21) Appl. No.: 19/161,056

(22) PCT Filed: Feb. 29, 2024
(86) PCT No.: PCT/JP2024/007480

§ 371 Date: Aug. 29, 2025

(30) Foreign Application Priority Data
Mar. 3, 2023 (MY) PI2023001167

(51) Int. Cl. B65G 47/44; B65G 11/14; B65G 11/18; B65G 43/00

(52) U.S. Cl. CPC B65G 47/44; B65G 11/143; B65G 11/183; B65G 43/00; B65G 2203/0283

(57) ABSTRACT

A retractable sliding chute includes (1): a plurality of chutes (2,3) which have respective inclined surfaces (21a,31a) that cause an article received from above to slide down; and a moving part (34) which causes at least one of the plurality of chutes (2,3) to be moved so that the retractable sliding chute (1) is brought into a retraction state from a use state, the retraction state being a state in which at least a portion of at least one of the inclined surfaces (21a, 31a) overlaps another of the inclined surfaces in a vertical direction, the use state being a state in which the inclined surfaces (21a, 31a) are continuously arranged so that the article slides down on all of the inclined surfaces (21a, 31a).

### TECHNICAL FIELD

The present invention relates to a chute down which an article slides, and the like.

### BACKGROUND ART

As disclosed in, for example, Patent Literature 1, a chute receives an article which has been conveyed and sorted by a conveying and sorting device such as a conveyor, and causes the article to slide down.

### CITATION LIST

### Patent Literature

[PTL 1] Japanese Patent Application Publication, Tokukai, No. 2013-189268

### SUMMARY OF INVENTION

### Technical Problem

For example, in an airport, a chute is disposed next to a conveyor which conveys baggage. Therefore, no space for an operator to enter is typically present between the conveyor and the chute.

In a case where it is desired to make such a space, for example, for maintenance purpose, it is necessary to move the entirety of the chute so that the chute is away from the conveyor. As the size or the weight of the chute increases, more time and effort are required to move the chute. Moreover, in a case where it is not possible to make a path along which the chute is moved because, for example, the chute is installed in a narrow place, it is not possible to, in the first place, move the chute. Therefore, it is not possible to make the space.

The object of an aspect of the present invention is to easily make a space in a place in which a chute is disposed.

### Solution to Problem

In order to attain the above object, a retractable sliding chute in accordance with an aspect of the present invention is a retractable sliding chute including: a plurality of chutes which have respective inclined surfaces that cause an article received from above to slide down; and a moving part which causes at least one of the plurality of chutes to be moved so that the retractable sliding chute is brought into a retraction state from a use state, the retraction state being a state in which at least a portion of at least one of the inclined surfaces overlaps another of the inclined surfaces in a vertical direction, the use state being a state in which the inclined surfaces are continuously arranged so that the article slides down on all of the inclined surfaces.

### ADVANTAGEOUS EFFECTS OF INVENTION

According to a retractable sliding chute in accordance with an aspect of the present invention, it is possible to easily make a space in a place in which a chute is disposed.

### BRIEF DESCRIPTION OF DRAWINGS

FIG. 1 is a perspective view illustrating a configuration of a retractable sliding chute in accordance with Embodiment 1.

FIG. 2 is a side view illustrating the configuration of the retractable sliding chute.

FIG. 3 is a perspective view illustrating the retractable sliding chute in a state where an upper chute is moved toward a lower chute.

FIG. 4 is a side view illustrating the retractable sliding chute in the state where the upper chute is moved toward the lower chute.

FIG. 5 is a perspective view illustrating a configuration of a portion of a movable leg of the upper chute.

FIG. 6 is a side view illustrating the configuration of the portion of the movable leg.

FIG. 7 is a front view illustrating the configuration of the portion of the movable leg.

FIG. 8 is a front view illustrating, in an enlarged manner, a connection structure between a support pillar and a fixing member of the movable leg.

FIG. 9 is a side view illustrating a configuration of a retractable sliding chute in accordance with Embodiment 2.

FIG. 10 is a side view illustrating the retractable sliding chute, illustrated in FIG. 9, in a state where a lower chute is moved toward an upper chute.

FIG. 11 is a side view illustrating a configuration of a retractable sliding chute in accordance with Embodiment 3.

FIG. 12 is a side view illustrating the retractable sliding chute, illustrated in FIG. 11, in a state where an upper chute and a middle chute are moved toward a lower chute.

FIG. 13 is a side view illustrating a configuration of a retractable sliding chute in accordance with Embodiment 4.

FIG. 14 is a side view illustrating the retractable sliding chute, illustrated in FIG. 13, in a state where a lower chute and a middle chute are moved toward an upper chute.

FIG. 15 is a block diagram illustrating a configuration of a transport system in accordance with Embodiment 5.

FIG. 16 is a flowchart illustrating a procedure of control of a conveyor which control is carried out by a control device of the transport system.

### DESCRIPTION OF EMBODIMENTS

### Embodiment 1

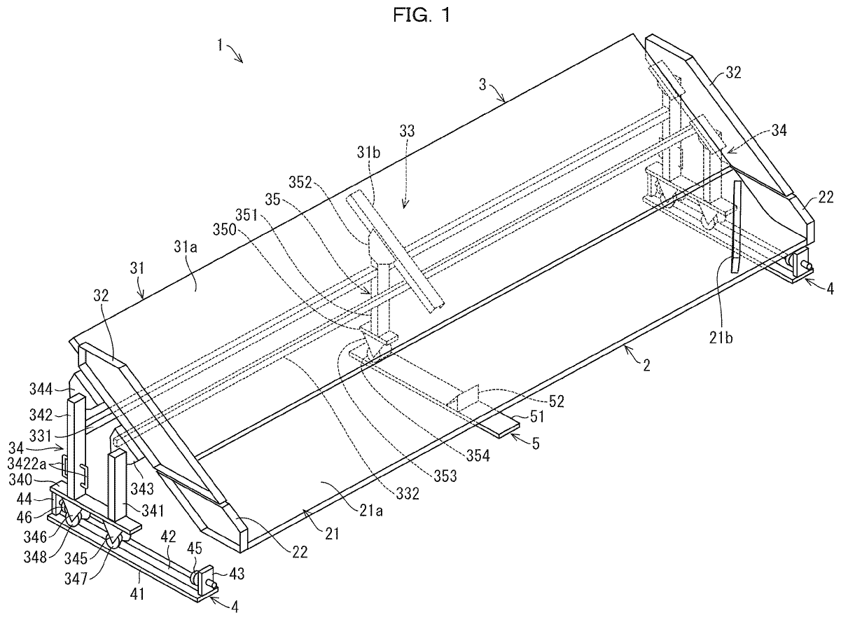

The following description will discuss, in detail, Embodiment 1 of the present invention with reference to FIGS. 1 through 8.

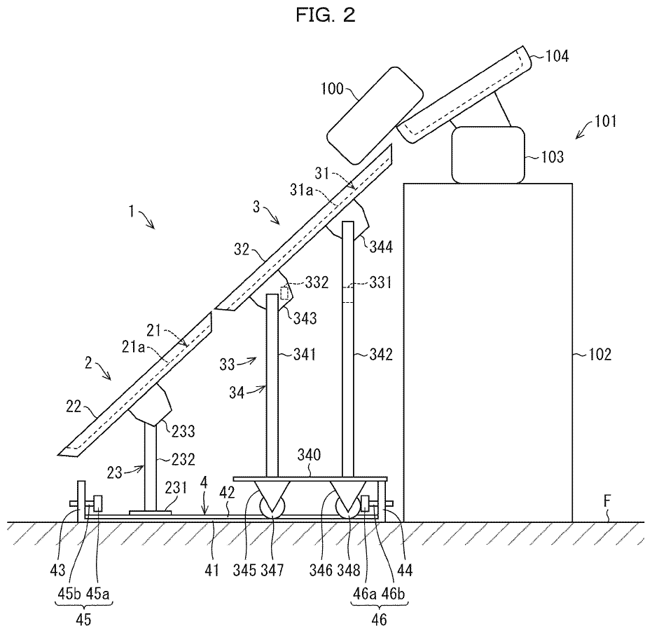

FIG. 1 is a perspective view illustrating a configuration of a retractable sliding chute 1 in accordance with Embodiment 1. FIG. 2 is a side view illustrating the configuration of the retractable sliding chute 1. Hereinafter, the retractable sliding chute 1 will be simply referred to as a chute 1.

As illustrated in FIGS. 1 and 2, the chute 1 includes a lower chute 2, an upper chute 3, rails 4, and a roller plate 5. The chute 1 is installed on an installation surface F so as to be in proximity to a conveyor 101. The chute 1 receives an article 100 which has been conveyed by the conveyor 101, and causes the article 100 to slide down.

The conveyor 101 is a conveying and sorting device which conveys the article 100 to an intended position, and is installed on the installation surface F. The conveyor 101 includes a main body 102, a moving body 103, and a tray 104 (sorter). The moving body 103 is provided so as to be moved on the main body 102. The tray 104 is mounted on the moving body 103 so as to be moved together with the moving body 103. On the tray 104, a single article 100 is placed. When the tray 104 reaches a sorting position, the tray 104 is tilted toward the chute 1 so that the article 100 is sent out to the chute 1, as illustrated in FIG. 2.

In the chute 1, the lower chute 2 is located in a lower stage. The lower chute 2 includes an inclined plate 21, side guides 22, and fixing legs 23.

The inclined plate 21 has a long rectangular shape, and is made of a material having a smooth surface, such as stainless steel. The inclined plate 21 has, on an upper side thereof, an inclined surface 21a (second inclined surface) which causes the article 100 to slide down thereon.

The inclined surface 21a is formed such that an angle of inclination of a portion of the inclined surface 21a which portion extends from an upper end to an intermediate area is greater than an angle of inclination of a portion of the inclined surface 21a which portion extends from the intermediate area to a lower end. This causes the article 100 to (i) slide down on the portion of the inclined surface 21a which portion extends from the upper end to the intermediate area and (ii) slow down when the article 100 reaches the portion of the inclined surface 21a which portion extends from the intermediate area to the lower end. On the inclined surface 21a, a gathering member 21b is provided. The gathering member 21b is disposed so as to be inclined with respect to any one of the side guides 22 so that the article 100 which slides down on the inclined surface 21a is gathered toward the middle of the inclined surface 21a.

The side guides 22 are fixed to respective side edges of the inclined plate 21 which are located on short-side sides of the inclined plate 21. Each of the side guides 22 is a plate member which guides the article 100 so as not to let the article 100 out the inclined plate 21 sideward. A peripheral portion of each of the side guides 22 is folded outward so that the each of the side guides 22 has increased strength.

Each of the fixing legs 23 is a structure which is disposed on the installation surface F and which supports the inclined plate 21 in a fixed manner, and is made of, for example, a steel material. The fixing legs 23 are disposed so as to be aligned at given intervals in a long direction of the inclined plate 21. Each of the fixing legs 23 includes a base 231, a support pillar 232, and a fixing member 233.

The base 231 is a flat plate-like member, and is disposed on the installation surface F. The base 231 may be fixed to the installation surface F with use of a bolt or the like. The support pillar 232 is formed so as to stand perpendicularly to the base 231. The fixing member 233 is a member which fixes a corresponding one of the fixing legs 23 to a back surface of the inclined plate 21. The fixing member 233 is provided to an upper end portion of the support pillar 232.

In the chute 1, the upper chute 3 is located in an upper stage. The upper chute 3 includes an inclined plate 31, side guides 32, and a moving mechanism 33 (moving part).

The inclined plate 31 has a long rectangular shape, and is made of a material having a smooth surface, such as stainless steel. The inclined plate 31 has, on an upper side thereof, an inclined surface 31 a (first inclined surface) which is flat and which causes the article 100 to slide down thereon. The inclined surface 31a has the same angle of inclination as the angle of inclination of the portion of the inclined surface 21a which portion extends from the upper end to the intermediate area.

To a back surface of the inclined plate 31, at least one rib 31b is fixed. The at least one rib 31b is a rod-like member which extends in a short direction of the inclined plate 31. In a case where a plurality of ribs 31b are fixed to the back surface of the inclined plate 31, the plurality of ribs 31b are disposed at given intervals in a long direction of the inclined plate 31. The at least one rib 31b is provided so as to increase the strength of the inclined plate 31. Note that FIG. 1 illustrates only a single rib 31b for convenience.

The side guides 32 are fixed to respective side edges of the inclined plate 31 which are located on short-side sides of the inclined plate 31. Each of the side guides 32 is a plate member which guides the article 100 so as not to let the article 100 out the inclined plate 31 sideward. A peripheral portion of each of the side guides 32 is folded outward so that the each of the side guides 32 has increased strength.

The moving mechanism 33 is a mechanism which supports the inclined plate 31 in such a manner that, on the installation surface F, the inclined plate 31 can be moved toward the lower chute 2. The moving mechanism 33 includes two movable legs 34, a single movable leg 35, and transverse members 331 and 332. The movable legs 34 are provided to the respective side edges of the inclined plate 31 which are located on the short-side sides of the inclined plate 31. The movable leg 35 is disposed on an intermediate area of the inclined plate 31, that is, between the movable legs 34.

Each of the movable legs 34 includes a base 340, support pillars 341 and 342, fixing members 343 and 344, bearing members 345 and 346, and rollers 347 and 348.

The base 340 is a flat plate-like member, and has a rectangular shape. The base 340 is disposed such that a long direction of the base 340 is parallel to a direction in which a long direction of the side guides 32 is projected onto the installation surface F. The support pillars 341 and 342 are formed so as to stand perpendicularly to an upper surface of the base 340. The support pillar 341 is shorter than the support pillar 342. The support pillars 341 and 342 are disposed so as to be spaced out.

The support pillar 342 of one of the two movable legs 34 is connected to the support pillar 342 of the other of the two movable legs 34 by the transverse member 331 which is disposed so as to extend in the long direction of the inclined plate 31. The support pillar 342 is provided with two handles 3422a. One of the handles 3422a is disposed on a surface of the support pillar 342 which surface faces the support pillar 341, and the other of the handles 3422a is disposed on a surface opposite to the surface.

The fixing members 343 and 344 are members which fix a corresponding one of the movable legs 34 to the back surface of the inclined plate 31, and disposed so as to be spaced out. The fixing members 343 and 344 are provided to respective upper end portions of the support pillars 341 and 342. The fixing members 343 and 344 are fixed to a lower end surface of a corresponding one of the side guides 32. The fixing member 343 of one of the two movable legs 34 is connected to the fixing member 343 of the other of the two movable legs 34 by the transverse member 332 which is disposed so as to extend in the long direction of the inclined plate 31.

The bearing member 345 is a member which rotatably supports the roller 347. The bearing member 346 is a member which rotatably supports the roller 348. The bearing members 345 and 346 are disposed on a lower surface of the base 340 so as to be located below the respective support pillars 341 and 342. The rollers 347 and 348 are disposed so as to roll on a corresponding one of the rails 4. Surfaces of the rollers 347 and 348 which surfaces are in contact with a corresponding one of the rails 4 are each formed so as to be depressed.

Two rails 4 are provided so as to allow the respective movable legs 34 to be moved. The rails 4 are disposed so as to be parallel to each other and be spaced out with a distance therebetween which is slightly longer than a width of the inclined plate 31. Each of the rails 4 includes a support plate 41, a raised part 42, standing plates 43 and 44, and stoppers 45 and 46.

The support plate 41 is a long slender plate-like member, and is disposed such that a long direction of the support plate 41 corresponds to a direction in which the base 340 is moved. The raised part 42 is formed on an upper surface of the support plate 41 so as to be located in the middle in a width direction of the support plate 41 and extend in the long direction of the support plate 41. The raised part 42 is formed such that a cross section of the raised part 42 which cross section extends along a plane perpendicular to the long direction of the support plate 41 has a raised shape (for example, a triangle). The shape of the raised part 42 is not limited to any particular one, provided that the raised part 42 is formed so as to be in good contact with the surfaces of the rollers 347 and 348 which surfaces are in contact with a corresponding one of the rails 4.

The standing plate 43 is a plate-like member, and is provided to an end of the upper surface of the support plate 41, which end is located on a lower-chute-2 side, so as to stand. The standing plate 44 is a plate-like member, and is provided to an end of the upper surface of the support plate 41, which end is located on an upper-chute-3 side, so as to stand. The standing plates 43 and 44 are disposed so as to face each other.

The stopper 45 includes: a head part 45a which prevents movement of the roller 347; and a shaft part 45b. The head part 45a is disposed on a side of a surface of the standing plate 43 which surface faces the standing plate 44, that is, faces the roller 347. The shaft part 45b is an external thread, and is inserted in a hole of an internal thread, which is formed in the standing plate 43, so as to pass through the standing plate 43.

The stopper 46 includes: a head part 46a which prevents movement of the roller 348; and a shaft part 46b. The head part 46a is disposed on a side of a surface of the standing plate 44 which surface faces the standing plate 43, that is, faces the roller 348. The shaft part 46b is an external thread, and is inserted in a hole of an internal thread, which is formed in the standing plate 44, so as to pass through the standing plate 44.

The stopper 45 is configured such that (i) by rotating the head part 45a clockwise, the head part 45a is moved toward the standing plate 43 and (ii) by rotating the head part 45a counterclockwise, the head part 45a is moved away from the standing plate 43. The stopper 46 is configured such that (i) by rotating the head part 46a clockwise, the head part 46a is moved toward the standing plate 44 and (ii) by rotating the head part 46a counterclockwise, the head part 46a is moved away from the standing plate 44. In this manner, it is possible to adjust a position of the head part 45a of the stopper 45 and a position of the head part 46a of the stopper 46, that is, a position at which movement of the roller 347 is prevented and a position at which movement of the roller 348 is prevented.

The movable leg 35 includes a base 350, a support pillar 351, fixing members 352, a bearing member 353, and a roller 354.

The base 350 is a flat plate-like member, and has a rectangular shape. The base 350 is disposed so as to be parallel to the base 340. The support pillar 351 is formed so as to stand perpendicularly to an upper surface of the base 350. The support pillar 351 is joined to the transverse member 331 such that the support pillar 351 perpendicularly intersects the transverse member 331 in the middle in a long direction of the transverse member 331. With this configuration, the movable leg 35 is formed so as to be moved in tandem with the movable legs 34.

Each of the fixing members 352 is a member which fixes the movable leg 35 to the rib 31b of the inclined plate 31. The fixing members 352 are disposed on respective opposing side surfaces of the rib 31b. The fixing members 352 are provided to an upper end portion of the support pillar 351.

The bearing member 353 is a member which rotatably supports the roller 354. The bearing member 353 is disposed on a lower surface of the base 350 so as to be located below the support pillar 351. The roller 354 is disposed so as to roll on the roller plate 5. A surface of the roller 354 which surface is in contact with the roller plate 5 is formed so as to be planar or outwardly curved, unlike the surfaces of the rollers 347 and 348 which surfaces are in contact with a corresponding one of the rails 4.

The roller plate 5 is disposed so as to be parallel to the two rails 4. The roller plate 5 includes a support plate 51 and stoppers 52.

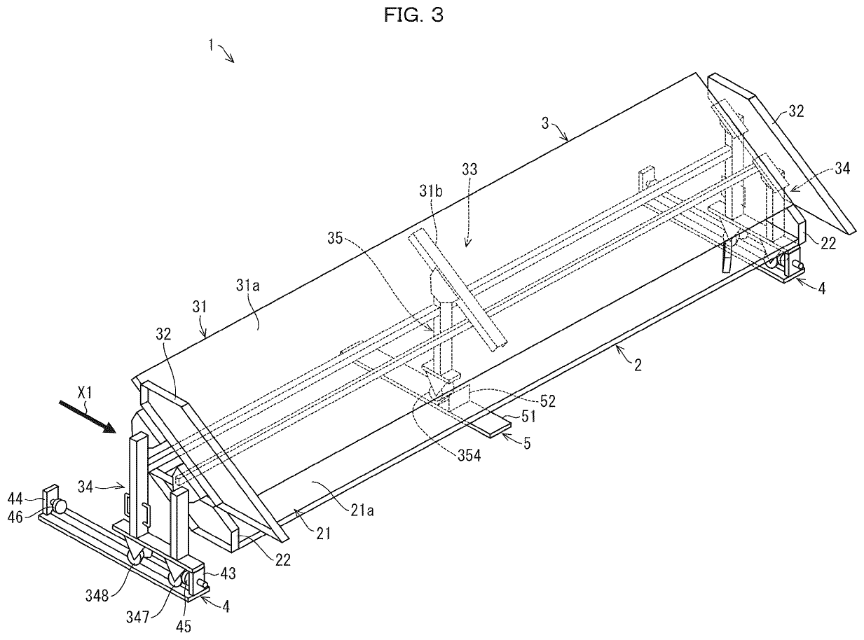

The support plate 51 is a plate-like member having a long slender rectangular shape. One of the stoppers 52 is provided at a position at which the one of the stoppers 52 prevents movement of the roller 354 on the lower-chute-2 side, and the other of the stoppers 52 is provided at a position at which the other of the stoppers 52 prevents the movement of the roller 354 on the upper-chute-3 side. Each of the stoppers 52 has a surface inclined with respect to the support plate 51 so that the roller 354 easily comes into contact with the each of the stoppers 52. Note that, for convenience, FIG. 1 and FIG. 3 (described later) each illustrate only one of the stoppers 52 which is provided on the lower-chute-2 side and each omit the other of the stoppers 52 which is provided on the upper-chute-3 side.

Next, movement of the upper chute 3 of the chute 1 configured as described above will be described.

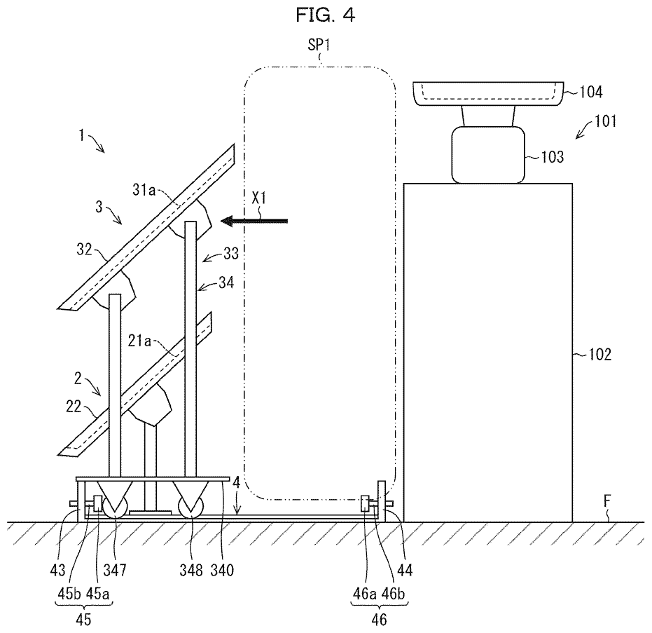

FIG. 3 is a perspective view illustrating the chute 1 in a state where the upper chute 3 is moved toward the lower chute 2. FIG. 4 is a side view illustrating the chute 1 in the state where the upper chute 3 is moved toward the lower chute 2.

In a state where the chute 1 is in ordinary use as illustrated in FIGS. 1 and 2, the inclined surfaces 21a and 31a are continuously arranged so that the article 100 slides down on all of the inclined surfaces 21a and 31a. Thus, the inclined surface 21a of the lower chute 2 receives the article 100 which slides down on the inclined surface 31a of the upper chute 3, and causes the article 100 to slide down thereon. In this use state, each of the movable legs 34 is fixed at a position at which the roller 348 is in contact with the stopper 46.

As illustrated in FIG. 2, an end portion of the base 340 which end portion is located on a roller-348 side overlaps, at a position at which the roller 348 is in contact with the head part 46a of the stopper 46, an upper end surface of the standing plate 44. In this state, a bolt is caused to pass through a long hole (not illustrated) formed in the end portion of the base 340 which end portion is located on the roller-348 side, and is tightened to a hole (not illustrated) formed in the upper end surface of the standing plate 44. As a result, the movable legs 34 are fixed to the respective rails 4.

From this use state, an operator holds any of the handles 3422a of the support pillar 342, and pushes the support pillar 342 in an X1 direction (that is, a direction in which the upper chute 3 is moved away from the conveyor 101). This causes the movable legs 34 of the moving mechanism 33 to be moved on the respective rails 4, and causes the movable leg 35 of the moving mechanism 33 to be moved on the roller plate 5. This ultimately causes the upper chute 3 to be moved toward the lower chute 2 in the X1 direction, as illustrated in FIGS. 3 and 4.

As illustrated in FIG. 4, an end portion of the base 340 which end portion is located on a roller-347 side overlaps, at a position at which the roller 347 is in contact with the head part 45a of the stopper 45, an upper end surface of the standing plate 43. In this state, a bolt is caused to pass through a long hole (not illustrated) formed in the end portion of the base 340 which end portion is located on the roller-347 side, and is tightened to a hole (not illustrated) formed in the upper end surface of the standing plate 43. As a result, the movable legs 34 are fixed to the respective rails 4.

This causes the upper chute 3 to be located on the lower-chute-2 side such that the inclined surface 31a overlaps the inclined surface 21a in a vertical direction, as illustrated in FIG. 4. In this retraction state, it is possible to make a space SP1 in a place in which the upper chute 3 has been presented in the use state. In this manner, it is possible to easily make the space SP1 in a portion of a place in which the chute 1 is disposed. Since the space SP1 is formed on a front side of the conveyor 101, the space S1 can be used not only as a path but also as a space for an operation, such as maintenance of the conveyor 101. Note, here, that the front side of the conveyor 101 is a side on which the article 100 is sent out from the tray 104.

Note that if it is possible to move the upper chute 3 so that the chute 1 is in the retraction state in which at least a portion of the inclined surface 31a of the upper chute 3 overlaps the inclined surface 21a of the lower chute 2 in the vertical direction, it is possible to make a space, though the space is not as large as the space SP1.

Note also that each of the movable legs 34 may include a mechanism which can fix each of the rollers 347 and 348 at any position, instead of fixing the base 340 to a corresponding one of the rails 4.

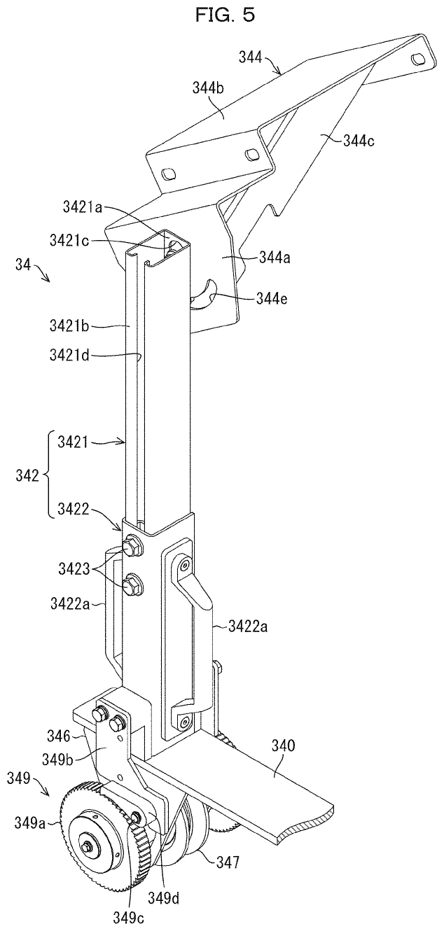

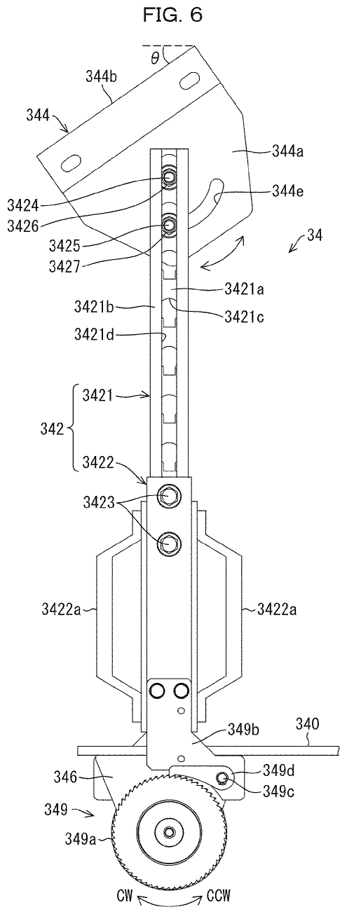

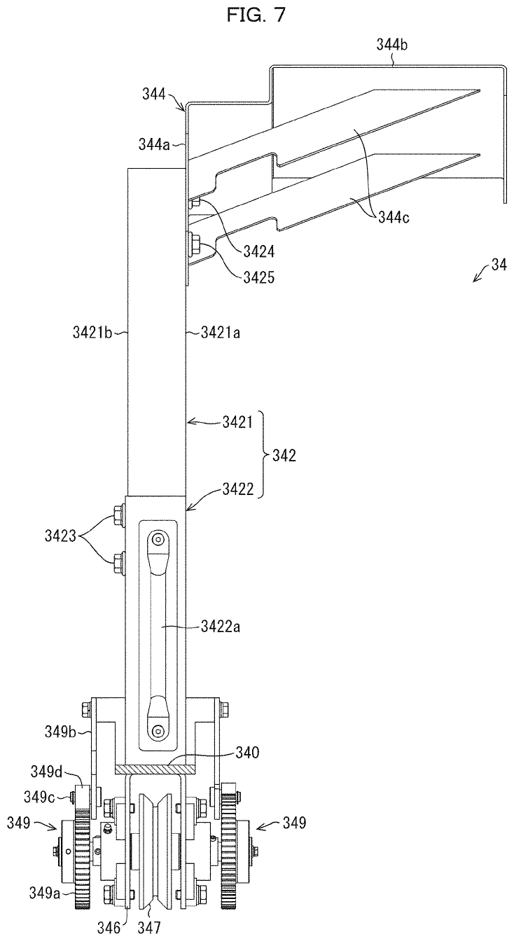

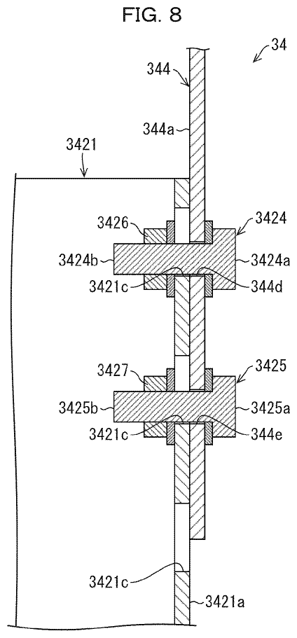

Next, the movable legs 34 will be described in detail. FIG. 5 is a perspective view illustrating a configuration of a portion of one movable leg 34 of the upper chute 3. FIG. 6 is a side view illustrating the configuration of the portion of the movable leg 34. FIG. 7 is a front view illustrating the configuration of the portion of the movable leg 34. FIG. 8 is a front view illustrating, in an enlarged manner, a connection structure between the support pillar 342 and the fixing member 344 of the movable leg 34.

As illustrated in FIGS. 5 through 7, the support pillar 342 of the movable leg 34 is divided into an upper part 3421 and a lower part 3422. The lower part 3422 has a tubular shape so that the upper part 3421 can be inserted into the lower part 3422, and a cross section thereof in a horizontal direction has a quadrangular shape. The upper part 3421 has a tubular shape, and a cross section thereof in the horizontal direction has a quadrangular shape and is slightly smaller than the cross section of the lower part 3422.

The upper part 3421 has a fixed surface 3421a and an opposed surface 3421b. The fixed surface 3421a is a surface which is fixed to the fixing member 344. The opposed surface 3421b is a surface which is opposed to the fixed surface 3421a. The fixed surface 3421a has a plurality of through-holes 3421c. The plurality of through-holes 3421c are formed so as to be spaced out in a long direction of the upper part 3421 and pass through the upper part 3421 in a thickness direction of the upper part 3421. In the opposed surface 3421b, a slit 3421d which extends in an up-and-down direction is formed.

A lower end portion of the upper part 3421 is inserted in the lower part 3422 from an upper end of the lower part 3422, and is supported by two bolts 3423. Specifically, the bolts 3423 pass through the lower part 3422, and pass through respective through-holes 3421c. Extreme ends of the bolts 3423 are fit in respective screw holes (not illustrated) formed in the lower part 3422.

By changing the through-holes 3421c through which the respective bolts 3423 pass, it is possible to change a position at which the upper part 3421 is supported by the lower part 3422. This makes it possible to change the height of an upper end of the upper part 3421, that is, the height of the support pillar 342. Thus, the upper part 3421, the lower part 3422, the through-holes 3421c, and the bolts 3423 constitute a height adjusting part which adjusts the height of the inclined surface 31a.

Similarly to the support pillar 342, the support pillar 341 has a structure in which the support pillar 341 is divided into an upper part and a lower part and a structure in which the upper part is supported by the lower part. This makes it possible to change the height of the support pillar 341. Similarly to the support pillar 342, the support pillar 232 of each of the fixing legs 23 has a structure in which the support pillar 232 is divided into an upper part and a lower part and a structure in which the upper part is supported by the lower part. This makes it possible to change the height of the support pillar 232.

As illustrated in FIG. 8, an upper end portion of the upper part 3421 is fixed to the fixing member 344 by bolts 3424 and 3425 and nuts 3426 and 3427. As illustrated in FIGS. 5 through 7, the fixing member 344 includes a first fixing part 344a, a second fixing part 344b, and brackets 344c.

The first fixing part 344a is a plate-like part to which the upper part 3421 is fixed, and has a through-hole 344d and an arc hole 344e. The through-hole 344d is a hole which passes through the first fixing part 344a. The arc hole 344e is a hole which is formed in the shape of an arc centered at the through-hole 344d. The arc hole 344e passes through the first fixing part 344a, and is formed below the through-hole 344d. The second fixing part 344b has a plate-like part which is fixed to the back surface of the inclined plate 31. Each of the brackets 344c connects the first fixing part 344a and the second fixing part 344b so that the entire fixing member 344 has increased strength.

A head part 3424a of the bolt 3424 is disposed on an inner-surface side of the first fixing part 344a. A shaft part 3424b of the bolt 3424 pass through the through-hole 344d of the first fixing part 344a and the uppermost through-hole 3421c of the upper part 3421. The nut 3426 is disposed in the upper part 3421, and is fit on the shaft part 3424b.

A head part 3425a of the bolt 3425 is disposed on the inner-surface side of the first fixing part 344a. A shaft part 3425b of the bolt 3425 pass through the arc hole 344e of the first fixing part 344a and the second top through-hole 3421c of the upper part 3421. The nut 3427 is disposed in the upper part 3421, and is fit on the shaft part 3425b.

The upper part 3421 is fixed to the fixing member 344 in a state where the nuts 3426 and 3427 are screwed on the respective bolts 3424 and 3425. The fixing member 344 can be rotated around the shaft part 3424b by moving, in the arc hole 344e, the shaft part 3425b of the bolt 3425 in a state where the nuts 3426 and 3427 are loosened. This makes it possible to adjust an angle of inclination θ of the fixing member 344 with respect to the upper part 3421, as illustrated in FIG. 6. Thus, the bolts 3424 and 3425, the nuts 3426 and 3427, the through-hole 344d, and the arc hole 344e constitute an angle adjusting part which adjusts the angle of inclination θ of the inclined surface 31 a.

The movable leg 34 includes a pair of ratchet mechanisms 349 (movement limiting part). The pair of the ratchet mechanisms 349 are provided on respective outer sides of the roller 347. Each of the ratchet mechanisms 349 is a mechanism which limits rotation of the roller 347 to one direction. Each of the ratchet mechanisms 349 includes a gear 349a, a support plate 349b, a support shaft 349c, and a pawl 349d. The gear 349a is fixed to a rotation shaft of the roller 347, and is rotated together with the roller 347. The support plate 349b is attached to the base 340 and the lower part 3422 so as to be disposed on a side of the bearing member 346. The support shaft 349c is fixed to the support plate 349b. The pawl 349d is rotatably supported on the support plate 349b by the support shaft 349c. The pawl 349d is biased toward the center of the gear 349a by a spring.

In a ratchet mechanism 349 illustrated in FIG. 6 and configured as described above, when it is intended to rotate the gear 349a counterclockwise CCW, teeth of the gear 349a push up an extreme end of the pawl 349d, so that it is possible to maintain rotation of the gear 349a. In contrast, in the ratchet mechanism 349, when it is intended to rotate the gear 349a clockwise CW, the extreme end of the pawl 349d bumps against the teeth of the gear 349a, so that it is possible to prevent rotation of the gear 349a.

Thus, the ratchet mechanism 349 allows the roller 347 to be rotated counterclockwise CCW, but does not allow the roller 347 to be rotated clockwise CW. Therefore, the ratchet mechanism 349 limits movement of the moving mechanism 33 to one direction.

The pair of the ratchet mechanisms 349 are opposite from each other in terms of a direction in which the pawl 349d prevents rotation of the gear 349a. In the left one of the ratchet mechanisms 349 illustrated in FIG. 7, counterclockwise CCW rotation of the gear 349a is not prevented and clockwise CW rotation of the gear 349a is prevented. In contrast, in the right one of the ratchet mechanisms 349 illustrated in FIG. 7, clockwise CW rotation of the gear 349a is not prevented and counterclockwise CCW rotation of the gear 349a is prevented, as viewed from the left side in FIG. 7. Therefore, by cancelling prevention of rotation of the gear 349a by the pawl 349d in any one of the ratchet mechanisms 349, it is possible to limit, to any one of two directions, a direction in which the moving mechanism 33 is moved.

### Embodiment 2

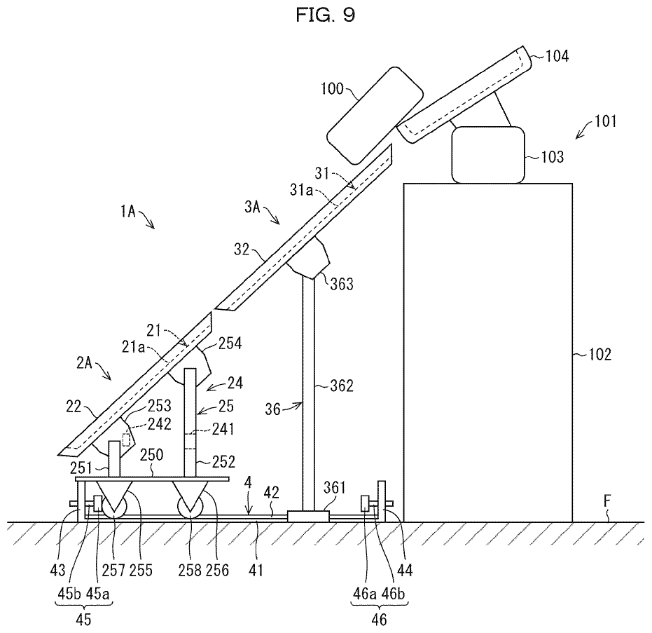

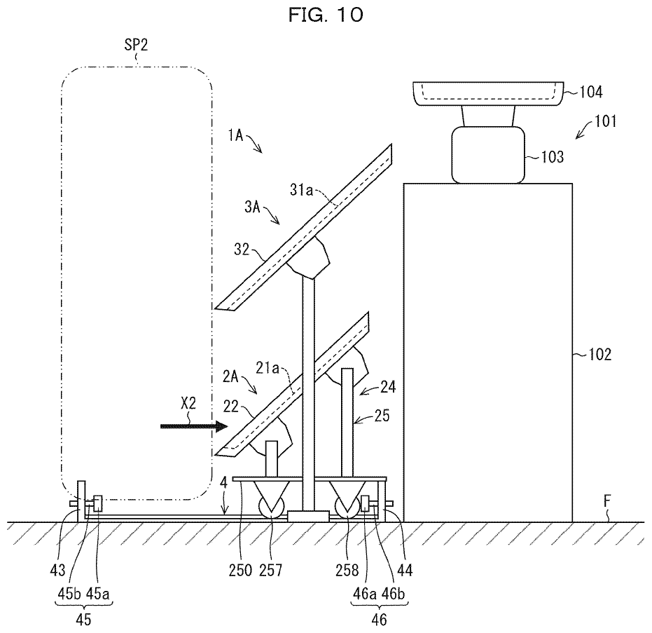

The following description will discuss, in detail, Embodiment 2 of the present invention with reference to FIGS. 9 and 10. Note that, in Embodiment 2, members having functions identical to those of members described in Embodiment 1 will be given respective identical reference signs and will not be described below, for convenience.

FIG. 9 is a side view illustrating a configuration of a retractable sliding chute 1A in accordance with Embodiment 2. Hereinafter, the retractable sliding chute 1A will be simply referred to as a chute 1A.

As illustrated in FIG. 9, the chute 1A includes a lower chute 2A, an upper chute 3A, rails 4, and a roller plate (not illustrated). The chute 1A is installed on an installation surface F so as to be in proximity to a conveyor 101. The chute 1A receives an article 100 which has been conveyed by the conveyor 101, and causes the article 100 to slide down.

The lower chute 2A includes an inclined plate 21, side guides 22, and a moving mechanism 24 (moving part).

The moving mechanism 24 is a mechanism which supports the inclined plate 21 in such a manner that, on the installation surface F, the inclined plate 21 can be moved toward the upper chute 3A. The moving mechanism 24 includes two movable legs 25, a single movable leg (not illustrated), and transverse members 241 and 242. The movable legs 25 are provided to respective side edges of the inclined plate 21 which are located on short-side sides of the inclined plate 21. The single movable leg is disposed on an intermediate area of the inclined plate 21, that is, between the movable legs 25.

Each of the movable legs 25 includes a base 250, support pillars 251 and 252, fixing members 253 and 254, bearing members 255 and 256, and rollers 257 and 258.

The base 250 is a flat plate-like member, and has a rectangular shape. The base 250 is disposed so that a long direction of the base 250 is parallel to a direction in which a long direction of the side guides 22 is projected onto the installation surface F. The support pillars 251 and 252 are formed so as to stand perpendicularly to an upper surface of the base 250. The support pillar 251 is shorter than the support pillar 252. The support pillars 251 and 252 are disposed so as to be spaced out.

The support pillar 252 of one of the two movable legs 25 is connected to the support pillar 252 of the other of the two movable legs 25 by the transverse member 241 which is disposed so as to extend in a long direction of the inclined plate 21. The support pillar 252 is provided with handles (not illustrated) similar to the two handles 3422a provided to the upper chute 3 of the chute 1 of Embodiment 1. One of the handles is disposed on a surface of the support pillar 252 which surface faces the support pillar 251, and the other of the handles is disposed on a surface opposite to the surface.

The fixing members 253 and 254 are members which fix a corresponding one of the movable legs 25 to a back surface of the inclined plate 21, and disposed so as to be spaced out. The fixing members 253 and 254 are provided to respective upper end portions of the support pillars 251 and 252. The fixing members 253 and 254 are fixed to a lower end surface of a corresponding one of the side guides 22. The fixing member 253 of one of the two movable legs 25 is connected to the fixing member 253 of the other of the two movable legs 25 by the transverse member 242 which is disposed so as to extend in the long direction of the inclined plate 21.

The bearing member 255 is a member which rotatably supports the roller 257. The bearing member 256 is a member which rotatably supports the roller 258. The bearing members 255 and 256 are disposed on a lower surface of the base 250 so as to be located below the respective support pillars 251 and 252. The rollers 257 and 258 are configured similarly to the respective rollers 347 and 348 provided to the upper chute 3 of the chute 1 of Embodiment 1.

The movable leg (not illustrated) provided between the two movable legs 25 is configured similarly to the movable leg 35 provided to the upper chute 3 of the chute 1 of Embodiment 1. Note, however, that since, unlike the inclined plate 31, the inclined plate 21 does not have, on the back surface thereof, a rib like the rib 31b, a fixing member which is included in the movable leg and which corresponds to the fixing members 352 of the movable leg 35 is directly fixed to the back surface of the inclined plate 21. A support pillar of the movable leg is joined to the transverse member 241 so that the support pillar perpendicularly intersects the transverse member 241 in the middle of the transverse member 241. With this configuration, the movable leg is formed so as to be moved in tandem with the movable legs 25.

The roller plate (not illustrated) is disposed so as to be parallel to the two rails 4. The roller plate is configured similarly to the roller plate 5 provided to the upper chute 3 of the chute 1 of Embodiment 1.

The upper chute 3A includes an inclined plate 31, side guides 32, and fixing legs 36.

Each of the fixing legs 36 is a structure which is disposed on the installation surface F and which supports the inclined plate 31 in a fixed manner, and is made of, for example, a steel material. The fixing legs 36 are disposed at given intervals in a long direction of the inclined plate 31. Each of the fixing legs 36 includes a base 361, a support pillar 362, and a fixing member 363.

The base 361 is a flat plate-like member, and is disposed on the installation surface F. The base 361 may be fixed to the installation surface F with use of a bolt or the like. The support pillar 362 is formed so as to stand perpendicularly to the base 361. The fixing member 363 is a member which fixes a corresponding one of the fixing legs 36 to a back surface (rib 31b) of the inclined plate 31. The fixing member 363 is provided to an upper end portion of the support pillar 362.

Next, movement of the lower chute 2A of the chute 1A configured as described above will be described.

FIG. 10 is a side view illustrating the chute 1A, illustrated in FIG. 9, in a state where the lower chute 2A is moved toward the upper chute 3A.

In a state where the chute 1A is in ordinary use as illustrated in FIG. 9, the inclined surfaces 21a and 31a are continuously arranged so that the article 100 slides down on all of the inclined surfaces 21a and 31a. Thus, the inclined surface 21a of the lower chute 2A receives the article 100 which slides down on the inclined surface 31a of the upper chute 3A, and causes the article 100 to slide down thereon. In this use state, each of the movable legs 25 is fixed at a position at which the roller 257 is in contact with a stopper 45.

As illustrated in FIG. 9, an end portion of the base 250 which end portion is located on a roller-257 side overlaps, at a position at which the roller 257 is in contact with a head part 45a of the stopper 45, an upper end surface of a standing plate 43. In this state, a bolt is caused to pass through a long hole (not illustrated) formed in the end portion of the base 250 which end portion is located on the roller-257 side, and is tightened to a hole (not illustrated) formed in the upper end surface of the standing plate 43. As a result, the movable legs 25 are fixed to the respective rails 4.

From this use state, an operator holds any of the handles of the support pillar 252, and pushes the support pillar 252 in an X2 direction (that is, a direction in which the lower chute 2A is moved toward the conveyor 101). This causes the movable legs 25 of the moving mechanism 24 to be moved on the respective rails 4, and causes the movable leg (not illustrated) of the moving mechanism 24 which movable leg is provided in the middle to be moved on the roller plate (not illustrated). This ultimately causes the lower chute 2A to be moved toward the upper chute 3A in the X2 direction, as illustrated in FIG. 10.

As illustrated in FIG. 10, an end portion of the base 250 which end portion is located on a roller-258 side overlaps, at a position at which the roller 258 is in contact with a head part 46a of a stopper 46, an upper end surface of a standing plate 44. In this state, a bolt is caused to pass through a long hole (not illustrated) formed in the end portion of the base 250 which end portion is located on the roller-258 side, and is tightened to a hole (not illustrated) formed in the upper end surface of the standing plate 44. As a result, the movable legs 25 are fixed to the respective rails 4.

This causes the lower chute 2A to be located on an upper-chute-3A side such that the inclined surface 31a overlaps the inclined surface 21a in a vertical direction, as illustrated in FIG. 10. In this retraction state, it is possible to make a space SP2 in a place in which the lower chute 2A has been presented in the use state. In this manner, it is possible to easily make the space SP2 in a portion of a place in which the chute 1A is disposed. This makes it possible to widen a space on a side on which the chute 1A causes the article 100 to slide down.

Note that if it is possible to move the lower chute 2A so that the chute 1A is in the retraction state in which at least a portion of the inclined surface 21a of the lower chute 2A overlaps the inclined surface 31a of the upper chute 3A in the vertical direction, it is possible to make a space, though the space is not as large as the space SP2.

Note also that each of the movable legs 25 may include a mechanism which can fix each of the rollers 257 and 258 at any position, instead of fixing the base 250 to a corresponding one of the rails 4.

### Embodiment 3

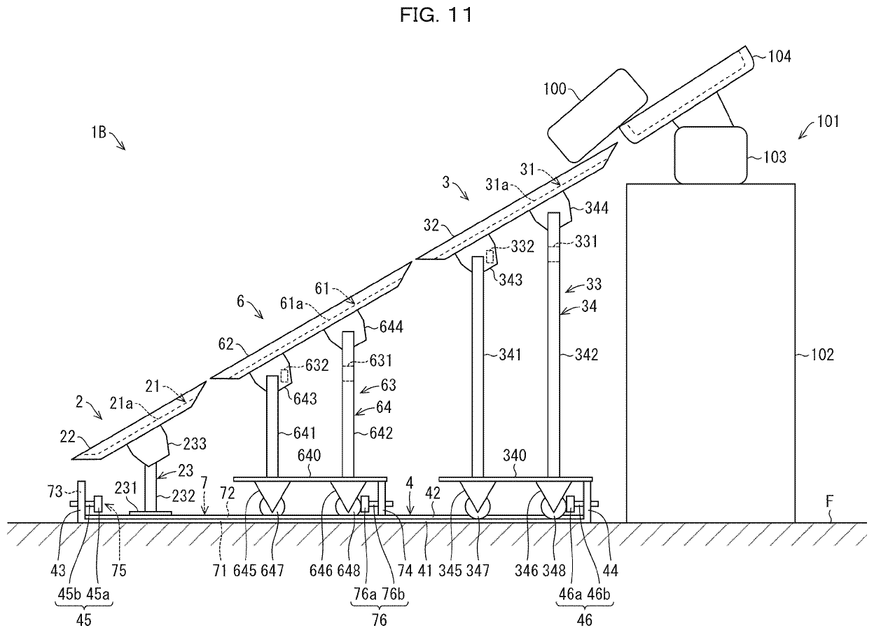

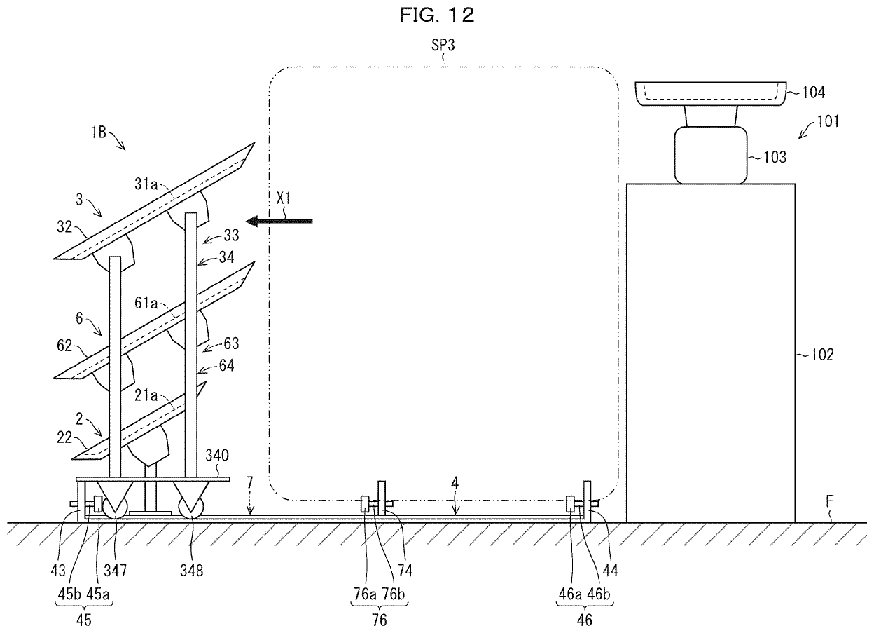

Embodiments 1 and 2 above have each described a retractable sliding chute including two chutes. However, the retractable sliding chute may include three or more chutes. In Embodiment 3 of the present invention, an example of a retractable sliding chute including three chutes will be described in detail, with reference to FIGS. 11 and 12. Note that, in Embodiment 3, members having functions identical to those of members described in Embodiments 1 and 2 will be given respective identical reference signs and will not be described below, for convenience.

FIG. 11 is a side view illustrating a configuration of a retractable sliding chute 1B in accordance with Embodiment 3. Hereinafter, the retractable sliding chute 1B will be simply referred to as a chute 1B.

As illustrated in FIG. 11, the chute 1B includes a lower chute 2, an upper chute 3, a middle chute 6, rails 4, rails 7, a roller plate 5, and another roller plate (not illustrated). The chute 1B is installed on an installation surface F so as to be in proximity to a conveyor 101. The chute 1B receives an article 100 which has been conveyed by the conveyor 101, and causes the article 100 to slide down. In order that the chute 1B causes the article 100 to slide down, the lower chute 2, the upper chute 3, and the middle chute 6 have an inclined surface 21a, an inclined surface 31a, and an inclined surface 61a, respectively, which differ from each other in height and which are formed so that the article 100 continuously slides down.

The middle chute 6 includes an inclined plate 61, side guides 62, and a moving mechanism 63 (moving part).

The inclined plate 61 is configured similarly to an inclined plate 31. The inclined plate 61 is disposed at a position which is higher than that of an inclined plate 21 and which is lower than that of the inclined plate 31. The side guides 62 are configured similarly to side guides 32.

The moving mechanism 63 is a mechanism which supports the inclined plate 61 in such a manner that, on the installation surface F, the inclined plate 61 can be moved toward the lower chute 2. The moving mechanism 63 includes two movable legs 64, a single intermediate movable leg (not illustrated), and transverse members 631 and 632. The movable legs 64 are provided to respective side edges of the inclined plate 61 which are located on short-side sides of the inclined plate 61. The intermediate movable leg is disposed on an intermediate area of the inclined plate 61, that is, between the movable legs 64. Further, the intermediate movable leg is disposed at a position at which, although the intermediate movable leg can be moved in the same direction as a movable leg 35 in Embodiment 1 above, the intermediate movable leg does not interfere with the movable leg 35. Each of the movable legs 64 includes a base 640, support pillars 641 and 642, fixing members 643 and 644, bearing members 645 and 646, and rollers 647 and 648.

The moving mechanism 63 is configured similarly to a moving mechanism 33, except that the heights of the support pillars 641 and 642 are lower than those of support pillars 341 and 342 and a distance between the movable legs 64 is shorter than that between moveable legs 34.

The rails 4 are formed so as to be longer than the rails 4 of the chute 1 in Embodiment 1.

Two rails 7 are provided so that the movable legs 64 are respectively moved. The rails 7 are formed so as to have the same length as the rails 4 of the chute 1 in Embodiment 1. The rails 7 are disposed between the rails 4 so as to be parallel to each other and be spaced out with a distance therebetween which is slightly longer than a width of the inclined plate 61. Each of the rails 7 includes a support plate 71, a raised part 72, standing plates 73 and 74, and stoppers 75 and 76.

The rails 7 have structures similar to those of the rails 4, expect that the rails 7 differ from the rails 4 in length. Thus, the detailed description of the structures of the rails 7 will be omitted.

In Embodiment 3, the upper chute 3 is moved on the rails 4, and the middle chute 6 is moved on the rails 7.

Next, movement of the upper chute 3 and the middle chute 6 of the chute 1B configured as described above will be described.

FIG. 12 is a side view illustrating the chute 1B, illustrated in FIG. 11, in a state where the upper chute 3 and the middle chute 6 are moved toward the lower chute 2.

In a state where the chute 1B is in ordinary use as illustrated in FIG. 11, the lower chute 2, the upper chute 3, and the middle chute 6 are disposed at respective home positions. Further, the inclined surfaces 21a, 31a, and 61a are continuously arranged so that the article 100 slides down on all of the inclined surfaces 21a, 31a, and 61a. In this use state, movable legs 34 are each fixed at a position at which a roller 348 is in contact with a stopper 46, and the movable legs 64 are each fixed at a position at which a roller 648 is in contact with a stopper 76.

From this use state, an operator pushes the support pillar 342 of each of the movable legs 34 in an X1 direction, similarly to the chute 1 in Embodiment 1. This causes the upper chute 3 to be moved toward the lower chute 2 in the X1 direction, as illustrated in FIG. 12. Furthermore, the operator holds a handle of the support pillar 642 of each of the movable legs 64, and pushes the support pillar 642 in the X1 direction. This causes the movable legs 64 of the moving mechanism 63 to be moved on the respective rails 7, as illustrated in FIG. 12. Furthermore, the intermediate movable leg of the moving mechanism 63 which intermediate movable leg is provided near the middle is moved on the above-described another roller plate. This ultimately causes the middle chute 6 to be moved toward the lower chute 2 in the X1 direction, as illustrated in FIG. 12.

Note, here, that the another roller plate is disposed in a region in which the intermediate movable leg is moved, and is disposed so as to be parallel to the roller plate 5.

At a position illustrated in FIG. 12, the upper chute 3 is fixed to the rails 4, and the middle chute 6 is fixed to the rails 7. This causes the upper chute 3 and the middle chute 6 to be located on a lower-chute-2 side such that the inclined surfaces 31a and 61a overlap the inclined surface 21a in a vertical direction, as illustrated in FIG. 12. In this retraction state, it is possible to make a space SP3 in a place in which the upper chute 3 and the middle chute 6 have been presented in the use state. In this manner, it is possible to easily make the space SP3 in a portion of a place in which the chute 1B is disposed. Since the space SP3 is formed between the lower chute 2 and the conveyor 101, it is possible to widen a space on a front side of the conveyor 101.

It is only necessary that the moving mechanism 33 of the upper chute 3 and the moving mechanism 63 of the middle chute 6 can be moved so that at least a portion of at least one of the inclined surfaces 31a and 61a overlaps the inclined surface 21a of the lower chute 2 in the vertical direction. This makes it possible to make a space, though the space is not as large as the space SP3.

The chute 1B may include two or more middle chutes which differ from each other in height, instead of the middle chute 6. The same applies to Embodiment 4 described below.

### Embodiment 4

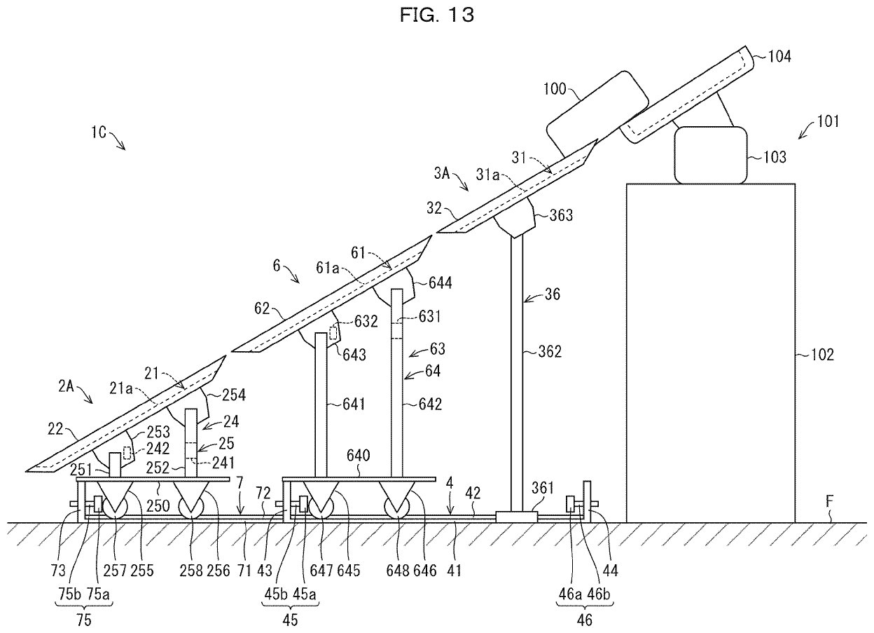

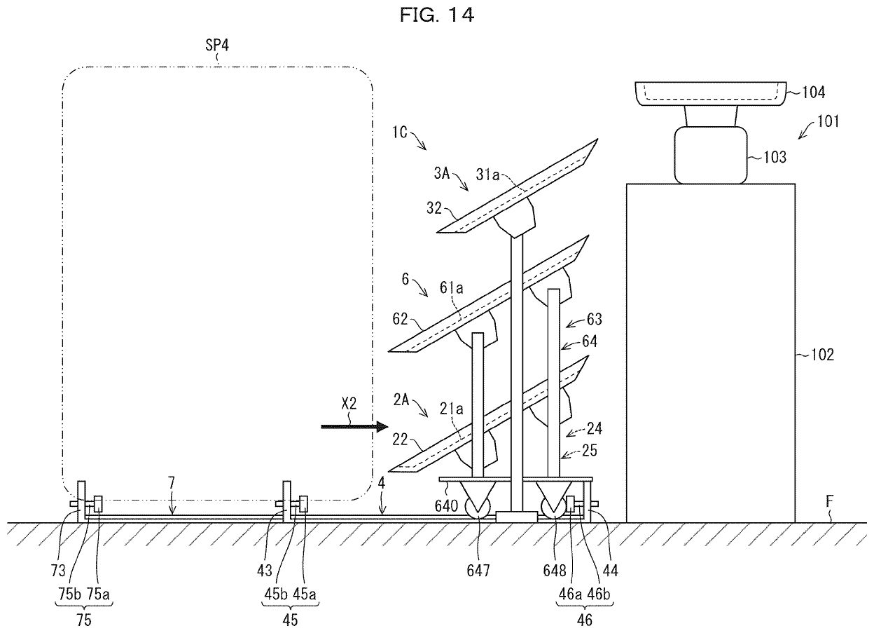

In Embodiment 4 of the present invention, another example of the retractable sliding chute including three chutes will be described in detail, with reference to FIGS. 13 and 14. Note that, in Embodiment 4, members having functions identical to those of members described in Embodiments 1 through 3 will be given respective identical reference signs and will not be described below, for convenience.

FIG. 13 is a side view illustrating a configuration of a retractable sliding chute 1C in accordance with Embodiment 4. Hereinafter, the retractable sliding chute 1C will be simply referred to as a chute 1C.

As illustrated in FIG. 13, the chute 1C includes a lower chute 2A, an upper chute 3A, a middle chute 6, rails 4, rails 7, a roller plate 5, and another roller plate (not illustrated). The chute 1C is installed on an installation surface F so as to be in proximity to a conveyor 101. The chute 1C receives an article 100 which has been conveyed by the conveyor 101, and causes the article 100 to slide down. In order that the chute 1C causes the article 100 to slide down, the lower chute 2A, the upper chute 3A, and the middle chute 6 have an inclined surface 21a, an inclined surface 31a, and an inclined surface 61a, respectively, which differ from each other in height and which are formed so that the article 100 continuously slides down.

The rails 4 have the same length as the rails 4 of the chute 1 in Embodiment 1. The rails 7 are formed so as to be longer than the rails 7 of the chute 1B in Embodiment 3. In Embodiment 4, the lower chute 2A is moved on the rails 7, and the middle chute 6 is moved on the rails 4.

Next, movement of the lower chute 2A and the middle chute 6 of the chute 1C configured as described above will be described.

FIG. 14 is a side view illustrating the chute 1C, illustrated in FIG. 13, in a state where the lower chute 2A and the middle chute 6 are moved toward the upper chute 3A.

In a state where the chute 1C is in ordinary use as illustrated in FIG. 13, the lower chute 2A, the upper chute 3A, and the middle chute 6 are disposed at respective home positions. Further, the inclined surfaces 21a, 31a, and 61a are continuously arranged so that the article 100 slides down on all of the inclined surfaces 21a, 31a, and 61a. In this use state, movable legs 25 are each fixed at a position at which a roller 257 is in contact with a stopper 75, and the movable legs 64 are each fixed at a position at which a roller 647 is in contact with a stopper 45.

From this use state, an operator pushes a support pillar 252 of each of the movable legs 25 in an X2 direction, similarly to the chute 1A in Embodiment 2. This causes the lower chute 2A to be moved toward the upper chute 3A in the X2 direction, as illustrated in FIG. 14. Furthermore, the operator pushes a support pillar 642 of each of the movable legs 64 in the X2 direction, similarly to the chute 1B in Embodiment 3. This causes the middle chute 6 to be moved toward the upper chute 3A in the X2 direction, as illustrated in FIG. 14.

At a position illustrated in FIG. 14, the lower chute 2A is fixed to the rails 7, and the middle chute 6 is fixed to the rails 4. This causes the lower chute 2A and the middle chute 6 to be located on an upper-chute-3A side such that the inclined surfaces 21a and 61a overlap the inclined surface 31a in a vertical direction, as illustrated in FIG. 14. In this retraction state, it is possible to make a space SP4 in a place in which the lower chute 2A and the middle chute 6 have been presented in the use state. In this manner, it is possible to easily make the space SP4 in a portion of a place in which the chute 1C is disposed. This makes it possible to widen a space on a side on which the chute 1C causes the article 100 to slide down.

It is only necessary that the lower chute 2A and the middle chute 6 can be moved so that at least a portion of the inclined surface 31a of the upper chute 3A is located above the inclined surface 21a of the lower chute 2A and the inclined surface 61a of the middle chute 6. This makes it possible to make a space, though the space is not as large as the space SP4.

### Variations of Embodiments 1 Through 4

The chute 1 of Embodiment 1 is configured such that the upper chute 3 is moved. On the other hand, the chute 1A of Embodiment 2 is configured such that the lower chute 2A is moved. However, the present invention is not limited such configurations. A retractable sliding chute may have a configuration in which a moving mechanism 33 of a chute 1 and a moving mechanism 24 of a chute 1A are combined with each other. This makes it possible to move both an upper chute and a lower chute toward the lower chute and the upper chute, respectively.

The chute 1B of Embodiment 3 is configured such that the upper chute 3 and the middle chute 6 are moved. On the other hand, the chute 1C of Embodiment 4 is configured such that the lower chute 2A and the middle chute 6 are moved. However, the present invention is not limited such configurations. A retractable sliding chute may have a configuration in which moving mechanisms 33 and 63 of a chute 1B and a moving mechanism 24 of a chute 1C are combined with each other. This makes it possible to move both (i) an upper chute and a middle chute and (ii) a lower chute and the middle chute toward the lower chute and the upper chute, respectively.

Furthermore, the chute 1B of Embodiment 3 may be configured such that the lower chute 2 can be moved, by replacing the lower chute 2 with the lower chute 2A of Embodiment 4, so that the lower chute 2A and the upper chute 3 are moved toward the middle chute 6. On the other hand, the chute 1C of Embodiment 4 may be configured such that the upper chute 3A can be moved, by replacing the upper chute 3A with the upper chute 3, so that the lower chute 2A and the upper chute 3 are moved toward the middle chute 6. In such configurations, it is not possible to make a wide space SP3 or SP4 as illustrated in FIGS. 12 and 14. However, it is possible to make spaces after the lower chute 2A and the upper chute 3 are moved.

### Embodiment 5

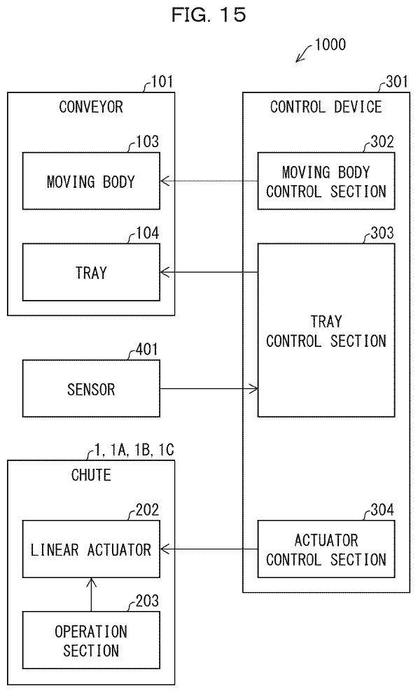

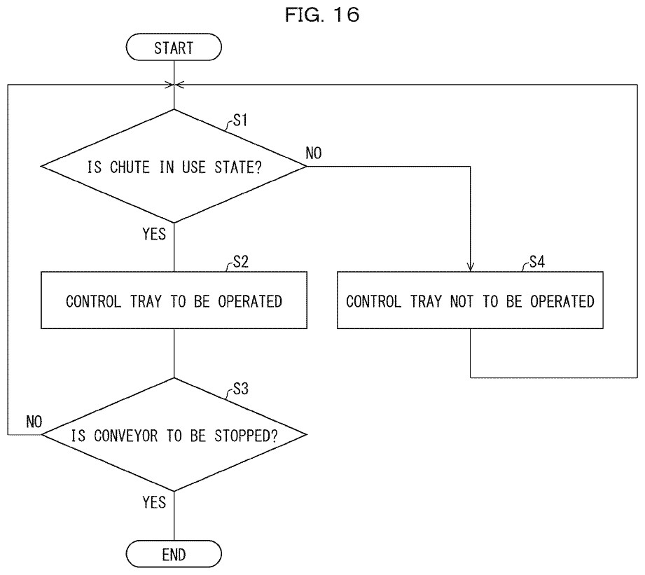

The following description will discuss, in detail, Embodiment 5 of the present invention with reference to FIGS. 15 and 16. Note that, in Embodiment 5, members having functions identical to those of members described in Embodiments 1 through 4 will be given respective identical reference signs and will not be described below, for convenience.

FIG. 15 is a block diagram illustrating a configuration of a transport system 1000 in accordance with Embodiment 5.

As illustrated in FIG. 15, the transport system 1000 includes the above-described conveyor 101, any one of the above-described chutes 1, 1A, 1B, and 1C, a control device 301, and a sensor 401. In the following description, in a case where the chutes 1, 1A, 1B, and 1C are mentioned, the chute 1 will be mentioned as a representative, for convenience.

The chute 1 includes a linear actuator 202 (linear actuating mechanism) and an operation section 203. The chute 1 may include the linear actuator 202 and the operation section 203, instead of or in addition to rollers 347 and 348 of a moving mechanism 33 and rails 4.

The sensor 401 detects that the chute 1 is in a use state, and also detects that the chute 1 is not in the use state. The sensor 401 detects that an upper chute 3, which is configured to be moved, is disposed at a position in an ordinary use state as illustrated in FIG. 2. For example, the sensor 401 is an optical sensor, and is disposed on an installation surface F and near the conveyor 101. However, the sensor 401 is not limited to such configurations.

The sensor 401 emits light upward, and receives light reflected back by a conveyor-101-side end portion of an inclined plate 31 of the upper chute 3 which is disposed at the position illustrated in FIG. 2. In this case, the sensor 401 detects that an inclined surface 21a of a lower chute 2 and an inclined surface 31a of the upper chute 3 are located at respective positions at which the inclined surfaces 21a and 31a allow an article 100 to continuously slide down thereon, that is, the chute 1 is in the use state. Thus, the inclined plate 31 has, on a lower surface thereof, a reflective surface (not illustrated) which reflects light from the sensor 401.

In a state where the upper chute 3 is disposed at a position illustrated in FIG. 4, the sensor 401 does not receive light reflected back from the inclined plate 31. In this case, the sensor 401 detects that the inclined surface 21a of the lower chute 2 and the inclined surface 31a of the upper chute 3 are not located at the respective positions at which the inclined surfaces 21a and 31a allow the article 100 to continuously slide down thereon, that is, the chute 1 is not in the use state. Note that the sensor 401 may be a sensor other than the optical sensor, e.g., a sensor which detects, on the basis of an image, whether the chute 1 is in the use state.

The linear actuator 202 is a mechanism which makes a linear motion, and includes a motor (not illustrated) and a motion converting mechanism (not illustrated). The motion converting mechanism is a mechanism which converts a rotational motion of the motor into a linear motion. Examples of the motion converting mechanism include a ball screw, a rack and pinion, and a timing belt.

The operation section 203 includes a switch and the like which an operator operates so as to cause the linear actuator 202 to be operated and stopped.

The control device 301 controls operations of the conveyor 101 and the linear actuator 202. The control device 301 includes a moving body control section 302, a tray control section 303, and an actuator control section 304.

The moving body control section 302 controls an operation of a moving body 103 of the conveyor 101.

The tray control section 303 controls an operation of a tray 104 of the conveyor 101. Specifically, the tray control section 303 controls the tray 104, with the article 100 placed thereon, to be tilted so that the article 100 which has been conveyed by the moving body 103 is sent out to the chute 1 which has been designated as a transport destination of the article 100 in advance. In a case where the tray control section 303 receives, from the sensor 401, a first detection signal (detection output) which indicates that the sensor 401 has detected that the chute 1 is in the use state, the tray control section 303 controls the tray 104 to be operated when the tray 104 reaches a position at which the article 100 is to be sent out to the chute 1. In a case where the tray control section 303 receives, from the sensor 401, a second detection signal (detection output) which indicates that the sensor 401 has detected that the chute 1 is not in the use state, the tray control section 303 controls the tray 104 not to be operated even when the tray 104 reaches the position at which the article 100 is to be sent out to the chute 1.

The actuator control section 304 controls an operation of the linear actuator 202. Specifically, the actuator control section 304 controls the linear actuator 202 not to be operated by an operation of the operation section 203, while the moving body control section 302 and the tray control section 303 are controlling the moving body 103 and the tray 104, respectively, to be operated.

Next, control of the operation of the tray 104, which control is carried out by the control device 301 with use of the sensor 401, will be described. FIG. 16 is a flowchart illustrating a procedure of control of the conveyor 101 which control is carried out by the control device 301 of the transport system 1000.

As illustrated in FIG. 16, the tray control section 303 first determines, on the basis of a signal from the sensor 401, whether the chute 1 is in the use state (step S1). In the step S1, in a case where the signal from the sensor 401 is the first detection signal, the tray control section 303 determines that the chute 1 is in the use state (YES), and controls the tray 104 to be operated (step S2).

Then, the tray control section 303 determines whether the conveyor 101 is to be stopped or not (step S3). In the step S3, in a case where the tray control section 303 determines, on the basis of the absence of an operation signal indicating that the conveyor 101 is in operation, that the conveyor 101 is to be stopped (YES), the tray control section 303 ends the process. In the step S3, in a case where the tray control section 303 determines, on the basis of the presence of the operation signal, that the conveyor 101 is not to be stopped (NO), the tray control section 303 returns the process to the step S1.

In the step S1, in a case where the signal from the sensor 401 is the second detection signal, the tray control section 303 (i) determines that the chute 1 is not in the use state (NO), (ii) controls the tray 104 not to be operated (step S4), and (iii) returns the process to the step S1.

As described above, in the transport system 1000, the actuator control section 304 controls the linear actuator 202 not to be operated by an operation of the operation section 203, while the conveyor 101 is in operation. Thus, the upper chute 3 of the chute 1 is not moved toward the lower chute 2 while the conveyor 101 is in operation. Therefore, it is possible to avoid a situation in which the article 100 that has been conveyed falls into a space SP1.

In a state where the conveyor 101 is not in operation because the control device 301 is not activated, it is possible to operate the linear actuator 202 by an operation of the operation section 203. Therefore, in a case where the conveyor 101 is operated while the chute 1 is not in the use state as a result of the linear actuator 202 being operated by an operation of the operation section 203, the article 100 which has been conveyed may fall into the space SP1.

In order to prevent this situation, in the transport system 1000, in a case where the tray control section 303 determines, on the basis of the second detection signal from the sensor 401, that the chute 1 is not in the use state, the tray control section 303 controls the tray 104 not to be operated. This makes it possible to avoid a situation in which the article 100 that has been conveyed falls into the space SP1.

In a case where the chute 1 is configured not to include the linear actuator 202 and is configured such that the upper chute 3 is moved on the rails 4 by rollers 347 and 348, it is not possible for the control device 301 to prevent movement of the upper chute 3 by the operator. Even in this case, in a case where the tray control section 303 determines, on the basis of the second detection signal from the sensor 401, that the chute 1 is not in the use state, the tray control section 303 controls the tray 104 not to be operated. Therefore, it is possible to avoid a situation in which the article 100 that has been conveyed falls into a space SP1.

Aspects of the present invention can also be expressed as follows:

A retractable sliding chute in accordance with a first aspect of the present invention is a retractable sliding chute including: a plurality of chutes which have respective inclined surfaces that cause an article received from above to slide down; and a moving part which causes at least one of the plurality of chutes to be moved so that the retractable sliding chute is brought into a retraction state from a use state, the retraction state being a state in which at least a portion of at least one of the inclined surfaces overlaps another of the inclined surfaces in a vertical direction, the use state being a state in which the inclined surfaces are continuously arranged so that the article slides down on all of the inclined surfaces.

According to the above configuration, at least one of the plurality of chutes is moved toward another. This allows a space to be made in a place in which a moved one of the plurality of chutes has been present before being moved. It is therefore possible to use this space as a path or as a space for an operation.

The retractable sliding chute in accordance with a second aspect of the present invention may be configured such that, in the first aspect, as the plurality of chutes, the retractable sliding chute includes an upper chute which is located in an upper stage and a lower chute which is located in a lower stage; and the moving part causes at least one of the upper chute and the lower chute to be moved so that at least a portion of an inclined surface of the upper chute is located above an inclined surface of the lower chute.

According to the above configuration, at least one of the upper chute and the lower chute is moved toward the other of the upper chute and the lower chute. This allows a space to be made in a place in which a moved one of the upper chute and the lower chute has been present before being moved. It is therefore possible to use this space as a path or as a space for an operation.

The retractable sliding chute in accordance with a third aspect of the present invention may be configured such that, in the second aspect, the lower chute is fixed to an installation surface on which the retractable sliding chute is installed; and the moving part causes the upper chute to be moved between a home position of the upper chute and a position above the lower chute.

According to the above configuration, the upper chute is moved toward the lower chute. This allows a space to be made in a place in which the moved upper chute has been present before being moved. It is therefore possible to use this space as a path or as a space for an operation. In particular, in a case where the retractable sliding chute causes an article, which has been sorted by a conveyor, to slide down, it is possible to make the space between the conveyor and the retractable sliding chute. It is therefore possible to easily conduct a maintenance operation etc. with respect to the conveyor.

The retractable sliding chute in accordance with a fourth aspect of the present invention may be configured such that, in the second aspect, the upper chute is fixed to an installation surface on which the retractable sliding chute is installed; and the moving part causes the lower chute to be moved between a home position of the lower chute and a position below the upper chute.

According to the above configuration, the lower chute is moved toward the upper chute. This allows a space to be made in a place in which the moved lower chute has been present before being moved. It is therefore possible to use this space as a path or as a space for an operation. In particular, in a case where the retractable sliding chute is installed in a narrow space, it is possible to widen a space on a side on which the retractable sliding chute causes the article to slide down.

The retractable sliding chute in accordance with a fifth aspect of the present invention may be configured to, in any one of the first through fourth aspects, further include a movement limiting part which limits movement of the moving part to one direction.

According to the above configuration, it is possible to avoid movement of the moving part in a direction in which the moving part is not intended to be moved.

The retractable sliding chute in accordance with a sixth aspect of the present invention may be configured such that, in any one of the first through fifth aspects, the moving part is a linear actuating mechanism which makes a linear motion.

According to the above configuration, it is possible to move at least one of the plurality of chutes without manpower.

The retractable sliding chute in accordance with a seventh aspect of the present invention may be configured such that, in any one of the first through sixth aspects, each of the plurality of chutes includes a height adjusting part which adjusts a height of a corresponding one of the inclined surfaces.

According to the above configuration, it is possible to adjust the heights of the inclined surfaces as desired. Therefore, it is possible to appropriately adjust the heights of the inclined surfaces so that the heights of the inclined surfaces fit for the height of a conveyor to which the retractable sliding chute is provided.

The retractable sliding chute in accordance with an eighth aspect of the present invention may be configured such that, in any one of the first through seventh aspects, each of the plurality of chutes includes an angle adjusting part which adjusts an angle of inclination of a corresponding one of the inclined surfaces.

According to the above configuration, it is possible to adjust the angles of inclination of the inclined surfaces as desired. Therefore, it is possible to appropriately adjust the angles of inclination of the inclined surfaces in accordance with the lengths of the inclined surfaces in a direction in which the inclined surfaces are inclined.

A transport system in accordance with a ninth aspect of the present invention is a transport system including: a retractable sliding chute of any one of the first through eighth aspects; a conveyor which conveys an article to the retractable sliding chute; a control device which controls the conveyor; and a sensor which detects whether the retractable sliding chute is in a use state, the control device controlling the conveyor on the basis of a detection output from the sensor.

According to the above configuration, it is possible to control the conveyor depending on whether the retractable sliding chute is in the use state or not.

The transport system in accordance with a tenth aspect of the present invention may be configured such that, in the ninth aspect, the conveyor includes a sorter which causes the article to be sent out to the retractable sliding chute; and in a case where the control device determines, on the basis of the detection output, that the retractable sliding chute is not in the use state, the control device controls the sorter so that the article is not sent out.

According to the above configuration, in a case where the retractable sliding chute is not in the use state, the sorter does not cause the article to be sent out. This makes it possible to avoid a situation in which the article send out from the sorter cannot slide down on the retractable sliding chute and consequently drops.

### Software Implementation Example

The control functions of the control device 301 (hereinafter referred to as a “device”) can be realized by a program for causing a computer to function as the device. The program is a program for causing a computer to function as control blocks (functions of the moving body control section 302, the tray control section 303, and the actuator control section 304) of the device.

In this case, the device includes, as hardware for executing the program, a computer which includes (i) at least one control unit (e.g., processor) and (ii) at least one storage device (e.g., memory). By the control unit and the storage device executing the program, the functions described in Embodiment 5 are realized.

The program may be stored in one or more non-transitory and computer-readable storage media. The one or more storage media may or may not be provided to the device. In the latter case, the program may be supplied to or made available to the device via any transmission medium by wire or wireless.

Further, some or all of the functions of the control blocks can be realized by a logic circuit. For example, the present invention encompasses, in its scope, an integrated circuit in which a logic circuit that functions as each of the control blocks is formed.

### Supplementary Note

The present invention is not limited to the embodiments above, but can be altered by a skilled person in the art within the scope of the claims. The present invention also encompasses, in its technical scope, any embodiment derived by combining technical means disclosed in differing embodiments. It is possible to form a new technical feature by combining the technical means disclosed in the respective embodiments.

### REFERENCE SIGNS LIST

1, 1A, 1B, 1C Retractable sliding chute
2, 2A Lower chute (chute)
3, 3A Upper chute (chute)
6 Middle chute (chute)
21a, 31a, 61a Inclined surface
24, 33, 63 Moving mechanism (moving part)
100 Article
101 Conveyor
104 Tray (sorter)
202 Linear actuator (linear actuating mechanism)
303 Tray control section
349 Ratchet mechanism (movement limiting part)
344d Through-hole
344e Arc hole
1000 Transport system
3421 Upper part
3423 Lower part
3421c Through-hole
3423, 3424, 3425 Bolt
3426, 3427 Nut
401 Sensor
F Installation surface
θ Angle of inclination

1. A retractable sliding chute comprising:
a plurality of chutes which have respective inclined surfaces that cause an article received from above to slide down; and
a moving part which causes at least one of the plurality of chutes to be moved so that the retractable sliding chute is brought into a retraction state from a use state, the retraction state being a state in which at least a portion of at least one of the inclined surfaces overlaps another of the inclined surfaces in a vertical direction, the use state being a state in which the inclined surfaces are continuously arranged so that the article slides down on all of the inclined surfaces.

2. The retractable sliding chute as set forth in claim 1, wherein:
as the plurality of chutes, the retractable sliding chute comprises an upper chute which is located in an upper stage and a lower chute which is located in a lower stage; and
the moving part causes at least one of the upper chute and the lower chute to be moved so that at least a portion of an inclined surface of the upper chute is located above an inclined surface of the lower chute.

3. The retractable sliding chute as set forth in claim 2, wherein:
the lower chute is fixed to an installation surface on which the retractable sliding chute is installed; and
the moving part causes the upper chute to be moved between a home position of the upper chute and a position above the lower chute.

4. The retractable sliding chute as set forth in claim 2, wherein:
the upper chute is fixed to an installation surface on which the retractable sliding chute is installed; and
the moving part causes the lower chute to be moved between a home position of the lower chute and a position below the upper chute.

5. The retractable sliding chute as set forth in claim 1, further comprising
a movement limiting part which limits movement of the moving part to one direction.

6. The retractable sliding chute as set forth in claim 1, wherein the moving part is a linear actuating mechanism which makes a linear motion.

7. The retractable sliding chute as set forth in claim 1, wherein each of the plurality of chutes includes a height adjusting part which adjusts a height of a corresponding one of the inclined surfaces.

8. The retractable sliding chute as set forth in claim 1, wherein each of the plurality of chutes includes an angle adjusting part which adjusts an angle of inclination of a corresponding one of the inclined surfaces.

9. A transport system comprising:
a retractable sliding chute recited in claim 1;
a conveyor which conveys an article to the retractable sliding chute;
a control device which controls the conveyor; and
a sensor which detects whether the retractable sliding chute is in a use state,
the control device controlling the conveyor on the basis of a detection output from the sensor.

10. The transport system as set forth in claim 9, wherein:
the conveyor includes a sorter which causes the article to be sent out to the retractable sliding chute; and
in a case where the control device determines, on the basis of the detection output, that the retractable sliding chute is not in the use state, the control device controls the sorter so that the article is not sent out.
